(19) United States
(12) Patent Application Publication
(10) Pub. No.: US 2007/0057909 A1
(43) Pub. Date: Mar. 15, 2007

(54) Display screen loudspeaker

(76) Inventors: Daniel Willem Elisabeth Schobben, Eindhoven (NL); Galileo June Adeva Destura, Eindhoven (NL); Martinus Hermanus Wilhelmus Maria Van Delden, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/557,680

(22) PCT Filed: May 19, 2004
(86) PCT No.: PCT/IB04/50741

§ 371 Date: Nov. 22, 2005

(30) Foreign Application Priority Data
May 28, 2003 (EP) 03101569.6

(51) Int. Cl. G09G 5/00

(52) U.S. Cl. 345/156

(57) ABSTRACT

An apparatus (1) comprising a display screen (150), the apparatus (1) further comprising means (24) for activating said display screen (150) to serve as a loudspeaker for reproducing an audio signal (A), means (20) for detecting if said display is viewed by a user of the apparatus, and means (22) for adjusting the reproduction of said audio signal (A) in order to reduce display distortion in dependence on said detecting (20) if said display screen (150) is viewed. An advantage of reproducing an audio signal (A) according to the invention is that audio properties normally causing optical distortion in the display screen (150) may be reproduced in situations where the user is not able to perceive the optical distortion. These audio properties may contribute to an advantageous reproduction of the audio signal (A).

The invention relates to an apparatus comprising a display screen and means for activating the display screen to serve as a loudspeaker for reproducing an audio signal. The invention further relates to a mobile phone and a PDA.

The company “NXT” (www.nxtsound.com) is working in the area of loudspeakers made out of flat or curved panels. NXT's technology enables the display screen of a mobile phone or a PDA to be turned into a loudspeaker. The integration of a loudspeaker into the display screen of a mobile phone results in a number of advantages. First, new product design possibilities arise as there is no need for a conventional speaker in the apparatus. Next, as the complete display is operating as a speaker, there is no need for a precise coupling between the ear of a user and the speaker of a mobile phone. Furthermore, it provides a better reproduction of a sound signal in comparison to a conventional speaker in a mobile phone, because of the large area of the display screen. This enables a wide frequency range of the audio signal to be reproduced and it allows high audio volumes necessary for hands-free operation of the mobile phone.

It is an object of the present invention to provide a reproduction of an audio signal by activating a display screen in an advantageous manner. To this end, the invention provides an apparatus and a method as specified in the independent claims. Advantageous embodiments are defined in the dependent claims.

An apparatus according to an embodiment of the invention comprises a display screen, means for activating the display screen to serve as a loudspeaker, means for detecting if the display screen is viewed by a user of the apparatus and means for adjusting the reproduction of the audio signal in order to reduce display distortion in dependence on the detection if the display screen is viewed. The invention is based on the insight that sound signals reproduced by the display screen may cause the display screen to be optically distorted. The distortion of the display screen may appear when certain volumes and frequencies of the audio signal have to be reproduced by the display or when other characteristics of the audio signal cause the display screen to distort. The distortion of the display screen is not a problem for a user when the display screen is not viewed by the user.

For example, when a mobile phone is held close to the ear, the display screen can not be seen and the distortion of the display screen can not be seen either. In situations where distortion can not be seen by the user, it is advantageous to allow the display screen to reproduce a wider frequency range of audio signals than conventional techniques that have to reduce display distortion at all times. As an example, NXT shows an embodiment of a mobile phone with a display screen serving as a speaker which allows a bandwidth of 600 Hz to 10 kHz (www.nxtsound.com). For the reproduction of an audio signal, a wider allowable bandwidth is advantageous. For example, when reproducing music sound signals, also frequencies below 600 Hz should preferably be reproduced. Also, a wider allowable bandwidth may be advantageous for reproducing voices, as a wider bandwidth may result in greater details of the reproduced audio signals. Furthermore, also other characteristics of the audio signal that may distort the display screen may be allowable when the display screen is not seen by the user which may be advantageous for audio reproduction.

When it is detected that the display screen is seen by the user, the reproduction of the audio signal may be adjusted by suppressing low frequencies of the audio signal. This aspect of the invention is based on the insight that a human eye is sensitive to low frequency vibrations. Therefore, when a display screen is mechanically vibrating in a low frequency, the human eye will be able to perceive the vibration which will be perceived as an optical distortion of the display screen. Furthermore, for reproducing low frequencies, larger deflections of the display screen are needed in comparison to reproducing higher frequencies.

Although low frequencies of the audio signal may cause optical distortion of the display screen, the audio signal may be reproduced without acoustical distortion. Therefore it is advantageous to reproduce these low frequencies when the display screen is not seen by the user. The human eye is particularly sensitive for mechanical movements with a frequency below approximately 50 Hz. Therefore, according to a further aspect of the invention, when a display screen is seen by the user, frequencies of the audio signal lower than 50 Hz are suppressed. Furthermore, frequencies of the audio signal lower than 500 Hz may cause local maxima and minima in the waves of vibration of the display screen, which may be perceived as inhomogeneity of pixel values in the display screen. This phenomenon may be perceived as color spots in the display screen. Therefore, according to another aspect of the invention, frequencies of the audio signal lower than 500 Hz are suppressed. The display distortion caused by local maxima and minima may be a result of the reproduction of an audio signal of frequencies within a frequency band. For a given display screen applicable in a mobile device, with given thickness, stiffness, cel-gap, sizes and other criteria of the display screen relevant for display distortion, the frequency band which may cause display distortion may for example be between 100 Hz and 400 Hz. It should be noted that the frequency band is mainly in dependence on the allowable cel-gap variation of the display screen which will be explained in the description of the figures. When other display screens are activated to serve as a speaker, other frequency ranges may be applicable.

According to an embodiment of the invention, psycho-acoustic means are used to give the user an illusion of perceiving frequencies of the audio signal that may cause display distortion, while these frequencies are suppressed in the physical reproduction of the audio signal. The psycho-acoustic means may give the user the illusion of perceiving frequencies that would possibly cause display distortion by physically reproducing higher order harmonics of these frequencies. Techniques that may be used for the psycho-acoustic means are known in the art. For example, WO-97/42789 discloses a circuit for processing an audio signal comprising a harmonics generator. An advantage is that when the display screen is seen by the user, the user perceives a wide frequency band including the frequencies causing display distortion while physically suppressing these frequencies. When the display screen is not seen by the user, the complete frequency band of the audio signal may be physically reproduced. Although the display may be distorted in that case, an advantage is that the psycho-acoustic means do not need to be active. This is advantageous as the psycho-acoustic means may cause acoustic artifacts.

In an embodiment of the invention, the detection if the display screen is seen by the user is performed by a switch operated by the user. The user may operate the switch for example when he is holding a mobile phone close to his ears. The switch may also be linked to another switch, for example the call-switch on a mobile phone possibly in dependence on whether or not a hands-free mode is used. When the user switches the call button without using the hands-free mode, it can be assumed that the phone is held close to the ear and the display can not be seen. An advantage of the detection by a switch is a relatively simple implementation, little processing power that is required and low energy consumption. In another embodiment of the invention, the detection is performed by an accelerometer. It is assumed that for example a mobile phone held by the user will shake more than when it is lying on the table. In a further embodiment of the invention, the detection if the display screen is seen by the user is performed by a proximity sensor. At a predetermined proximity of an apparatus, it may be assumed that the display can be seen by the user. When the distance between the user and the apparatus is substantially large in dependence on the size of the display, for example at least 1 meter when a small display screen is used for example in a mobile phone, it may be assumed that the display can not be seen by the user. Also, a proximity sensor may detect when a mobile phone is held close to the ear of the user. In that case, the display screen can not be seen by the user. The proximity sensor may comprise means for detecting an intensity of electromagnetic radiation. For example, a light intensity sensor may be used, possibly in combination with a light emitting diode in order to measure a reflection of light in dependence on the proximity of a user. Another example is that an infra red sensor may sense the proximity of a user. Or another possibility is to use a camera in combination with image processing algorithms for the detection of the proximity of the user. For example, the camera may apply a skin detection algorithm or an eye detection algorithm on images derived from the camera to detect if the apparatus is held close to the face of the user. These and other applicable image processing algorithms are known in the art. A further possibility for detecting the proximity of a user is to use an acoustic echo cancellation system that may be incorporated in the apparatus. For example, a mobile phone may comprise an acoustic echo cancellation system which estimates an acoustic transfer function between a microphone of the mobile phone and the display screen serving as a speaker. When the user is close to the mobile phone, the acoustic transfer function will be different from the acoustic transfer function estimated when the user is away from the mobile phone. The variation of the acoustic transfer function may therefore be detected in order to detect the proximity of the user.

The aforementioned and other aspects of the invention will be apparent from and elucidated with reference to the embodiments described hereinafter.

In the drawings:

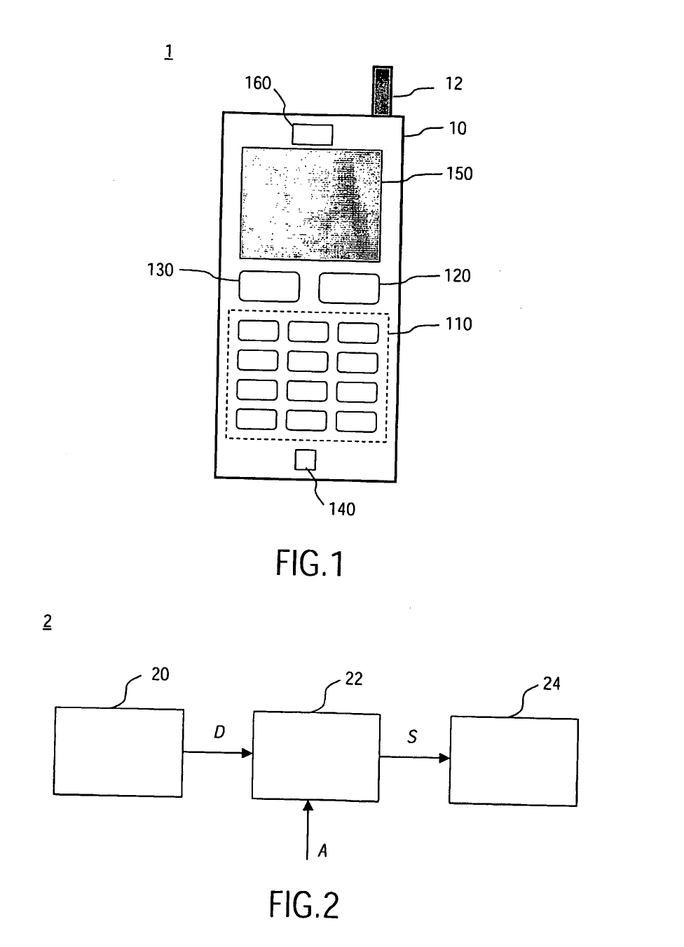

FIG. 1 shows an embodiment of a mobile phone according to the invention.

FIG. 2 shows a block diagram representing an embodiment of the method for reproducing an audio signal according to the invention.

FIG. 1 shows an embodiment of a mobile phone 1 according to the invention. The mobile phone 1 is explained as an example, but also another apparatus may comprise an embodiment according to the invention such as a PDA. The mobile phone 1 comprises a body 10 and an antenna 12. The antenna may also be incorporated as an internal antenna within the body 10. The mobile phone 1 further comprises a set of buttons 110 for operating the telephone, like inputting numbers or scrolling through an operating menu. The mobile phone 1 also comprises a call-button 120 for starting, ending or answering a call. These functions may also be operated by a plurality of buttons. The mobile phone 1 further comprises a display screen 150. The display screen 150 may be an LCD display screen, a TFT display screen or another display screen. The display screen serves for displaying data to the user, but it is also activated for serving as a loudspeaker for reproducing an audio signal.

The display screen 150 may be constructed from two parallel sheets of for example glass, which sheets are kept apart from each other by means of spacers. The spacers should keep the sheets at a small distance from each other which distance is homogenous over the surface of the display screen. The distance is called the cell-gap. Incoming light may reflect within the sheets of the display screen in dependence on the polarization of liquid crystals between the sheet. In that case the cell-gap is equal to a quarter of the wave length of the light that is reflected. As a result, the perceived color of the reflected light is dependent from the cell-gap. A variation in cell-gap may result in optical distortion perceived by the user.

There are various techniques for activating the display screen 150 to serve as a loudspeaker. For example, in a technique which is also known as a singing display screen, a voltage is applied over electrodes at both sides of the cell-gap. Because of a potential difference, the electrodes are pulled towards each other and the spacers are pushed in as if they were springs. When the potential difference is zero again, the spacers cause the sheets to be positioned back to their initial position. By varying the potential difference in dependence on the audio signal, the display screen 150 may serve as a loudspeaker. In another technique, which is also known as a swinging display screen, the display screen is activated by an activator like for example a piezo element which is mechanically coupled to the display screen. A voltage is applied on the piezo element in order to vibrate the display screen 150 in dependence on the audio signal, i.e. the display screen 150 serves as a loudspeaker.

When activating the display screen 150 to serve as a loudspeaker, optical display distortion may be the result of a variation in cell-gap. In a singing display screen, the cell-gap serves a spring and may be pushed in in dependence on the stiffness of the spring and the force, i.e. the potential over the electrodes. It should be noted that in order to reproduce an audio signal at a sufficient audio volume, the springs should not be very stiff.

As a result the sheets of a display screen may not vibrate like a homogenous package of layers. In a swinging display, the activator mechanically coupled to the display screen may cause a bending of the display screen. Bending the display screen may cause a variation in the cel-gap.

Light is reflected within the cell-gap with a wave length in dependence on the cell-gap. Therefore, a variation in cell-gap may cause an optical distortion. For example, with a nominal cell-gap of approximately 5 um, the allowable cell-gap variation may be around 80 nm. A cell-gap variation may be allowable when the cell-gap variation is within 1-2% of the cell-gap. Furthermore, the allowance of a cell-gap variation is dependent on the possibility to perceive the cell-gap variation. For example, a human eye is not capable of following vibrations of high frequencies like frequencies higher than approximately 1 kHz. A user will perceive an average of the variation, not the variation itself. However, variations of lower frequencies may be perceived by a user as an optical distortion of the display screen.

Furthermore, for reproducing low frequencies, larger deflections of the display screen are needed in comparison to reproducing higher frequencies which may result in larger cell-gap variations. For example, variations with frequencies lower than 50 Hz may be perceived as optical distortion. Another phenomenon which may cause optical distortion is the appearance of local maxima and minima in the waves of vibration of the display screen, which may be perceived as inhomogeneity of pixel values in the display screen. This phenomenon may be perceived as color spots in the display screen. This phenomenon may appear with vibrations of frequencies lower than 500 Hz or may appear in a frequency band such as the frequency band between 100 Hz en 400 Hz. It should be noted that the given frequencies are applicable for a given display screen applicable in a mobile device, with given thickness, stiffness, cel-gap, sizes and other criteria of the display screen relevant for display distortion. When other display screens are activated to serve as a speaker, other frequencies and frequency ranges may be applicable. It should be noted that the frequencies and frequency ranges are mainly in dependence on the allowable cell-gap variation.

The mobile phone 1 further comprises means for detecting if the display screen 150 is viewed by the user. For example, the mobile phone 1 may comprise a switch 130. The user may operate the switch 130 for example when he is holding the mobile phone 1 close to his ears. The switch may also be linked to another switch, for example the call-switch 120 on a mobile phone possibly in dependence on whether or not a hands-free mode is used. When the user switches the call button without using the hands-free mode, it can be assumed that the phone is held close to the ear and the display can not be seen. In order to detect if the display is viewed by the user, the mobile phone may comprise a sensor 160. This sensor 160 may also comprise an accelerometer. An accelerometer may be used for detecting if the display screen 150 is used when it is assumed that a mobile phone 1 shakes more when it is held by the user than when it is lying on a table for example. Furthermore, the sensor 160 may comprise means for detecting the proximity of the user. When the mobile phone 1 is held close to the ears of the user, the display screen 1 can not be seen. The display screen 150 can also not be seen when the mobile phone 1 is too far away from the user. The proximity detection means may comprise means for sensing an intensity of electromagnetic radiation. For example, the proximity detection means may comprise a light intensity sensor possibly in combination with a light emitting diode in order to detect a reflection of light because of a proximity of the user. Also, the proximity detection means may comprise a camera possibly in combination with image processing algorithms for example for a skin detection or an eye detection of the user's face. Instead of using a sensor 160 for detecting the proximity of the user, it is possible to detect the proximity of the user with a microphone 140 in combination with the display screen 150 serving as a loudspeaker. The microphone 140 may be the same microphone that is used for picking-up the user's voice when he is calling but this is not necessary. The mobile phone 1 may comprise an echo cancellation system which is known in the art. An echo cancellation system is for example advantageous when the mobile phone 1 is used in hands-free mode, in which mode the mobile phone 1 has to suppress sounds coming from the speaker in order to perceive the voice of the user. Therefore, an echo cancellation system estimates an acoustic transfer function between the microphone 140 and the display screen 150 serving as a loudspeaker. The acoustic transfer function is dependent on the proximity of the user. When the mobile phone 1 is held close to the ears for example, the transfer function is different from a situation in which sound may transfer from the loudspeaker 150 to the microphone 140 more easily when the user is away from the mobile phone 1. A variation in the acoustic transfer function may therefore be detected in order to detect the proximity of the user.

FIG. 2 shows a block diagram representing an embodiment of the method for reproducing an audio signal according to the invention. First, in step 20, it is detected if the user may view the display screen 150. As stated above, the detection may be performed by a switch 130, a sensor 160, an acoustic echo cancellation system detecting a variation in an acoustic transfer function between the microphone 140 and the display screen 150 serving as a loudspeaker, combinations thereof, or other detection means that are known in the art. In dependence on the detection result, a detection signal D is constituted. In step 22, an audio signal A is adjusted if the detection signal D indicates that the user may view the display screen 150. As stated above, there are properties of the audio signal A which may cause optical distortion. When the user may view the display screen 150, these properties are suppressed. This may be achieved by a filter, which may be a fixed filter or a controllable filter. For example, a high-pass filter may be used to suppress low frequencies of the audio signal A. Also, a band-pass filter may be used to suppress frequencies in a predetermined frequency range which frequencies may cause optical distortion. It is also possible to adjust the audio signal A in step 22 by using psycho-acoustic means as stated above for giving the user an illusion of perceiving frequencies that would normally cause optical distortion. This may be achieved by suppressing frequencies and adding higher harmonics of these frequencies. When the user may not be able to see the display screen 150, it is not necessary to adjust the audio signal A. The result from step 22 is a further audio signal S. Finally, in step 24, the audio signal S is physically reproduced by activating a display screen 150 to serve as a loudspeaker. As stated above, this may be performed by a technique called singing display screen, a technique called swinging display screen, combinations thereof, or other techniques for activating a display screen that are known in the art.

It should be noted that the above-mentioned embodiments illustrate rather than limit the invention, and that those skilled in the art will be able to design many alternative embodiments without departing from the scope of the appended claims. In the claims, any reference signs between parenthesis shall not be construed as limiting the claim. The word ‘comprising’ does not exclude the presence of other elements or steps than those listed in a claim. The invention can be implemented by means of hardware comprising several distinct elements, and by means of a suitably programmed computer. In a device claim enumerating several means, several of these means can be embodied by one and the same item of hardware. The mere fact that certain measures are recited in mutually different dependent claims does not indicate that a combination of these measures cannot be used to advantage.

1. An apparatus (1) comprising a display screen (150), the apparatus (1) further comprising:
means (24) for activating said display screen (150) to serve as a loudspeaker for reproducing an audio signal (A);
means (20) for detecting if said display screen (150) is viewed by a user of the apparatus; and
means (22) for adjusting the reproduction of said audio signal (A) in order to reduce display distortion in dependence on said detecting (20) if said display screen (150) is viewed.

2. The apparatus (1) as claimed in claim 1, wherein said means (22) for adjusting comprises means for suppressing low frequencies of said audio signal if said display screen (150) is viewed.

3. The apparatus (1) as claimed in claim 2, wherein said means (22) for suppressing low frequencies comprises means for suppressing frequencies of said audio signal (A) that are lower than 50 Hz.

4. The apparatus (1) as claimed in claim 2, wherein said means (22) for suppressing low frequencies comprises means for suppressing frequencies of said audio signal (A) that are lower than 500 Hz.

5. The apparatus (1) as claimed in claim 1, wherein said means (22) for adjusting comprises means for suppressing frequencies of said audio signal (A) within at least one frequency band if said display screen is viewed.

6. The apparatus (1) as claimed in claim 5, wherein said at least one frequency band comprises frequencies between 100 Hz and 400 Hz.

7. The apparatus (1) as claimed in claim 1, wherein said means (22) for adjusting comprises:
psycho-acoustic means to give the user an illusion of perceiving predetermined frequencies of said audio signal (A), and
means for suppressing said predetermined frequencies in the physical reproduction of said audio signal (A) by said means (24) for activating said display screen (150).

8. The apparatus (1) as claimed in claim 7, wherein said psycho-acoustic means comprises means for physically reproducing higher order harmonics of said predetermined frequencies of said audio signal (A).

9. The apparatus (1) as claimed in claim 1, wherein said means (20) for detecting comprises a switch (130) operated by said user.

10. The apparatus (1) as claimed in claim 1, wherein said means (20) for detecting comprises an accelerometer (160) for detecting changes in movement of said apparatus (1).

11. The apparatus (1) as claimed in claim 1, wherein said means (20) for detecting comprises means (160) for detecting a proximity of said user.

12. The apparatus (1) as claimed in claim 11, wherein said means (160) for detecting said proximity comprises means for sensing an intensity of electromagnetic radiation.

13. The apparatus (1) as claimed in claim 11, wherein said means (160) for detecting said proximity comprises:
means for acoustic echo cancellation comprising means to estimate an acoustic transfer function between a microphone (140) of said apparatus (1) and said display screen (150) serving as a loudspeaker; and
means to detect a change of said acoustic transfer function caused by said proximity of said user.

14. A method (2) for reproducing an audio signal (A), the method (2) comprising the steps of:
activating (24) a display screen (150) to serve as a loudspeaker;
detecting (20) if said display screen (150) is viewed by a user; and
adjusting (22) the reproduction of said audio signal (A) in order to reduce display distortion in dependence on said detecting step (20).
